(19) United States
(12) Patent Application Publication
(10) Pub. No.: US 2010/0299906 A1
(43) Pub. Date: Dec. 2, 2010

(54) APPARATUS AND METHOD OF FORMING THE BRAKE ACTUATOR

(75) Inventor: Wayne Hyde Oster, Redwood Valley, CO (US)

Correspondence Address: HOWARD & HOWARD ATTORNEYS PLLC, 450 West Fourth Street, Royal Oak, MI, 48067, US

(73) Assignee: INDIAN HEAD INDUSTRIES, INC., Charlotte, NC (US)

(21) Appl. No.: 12/473,434

(22) Filed: May 28, 2009

(51) Int. Cl. B23P 11/02; B23P 19/02

(52) U.S. Cl. 29/446; 29/235

(57) ABSTRACT

A apparatus for forming a brake actuator that includes a flange case defining a peripheral groove circumscribing a push rod movable axially in relation to the flange case whereby the push rod presents a push rod guide bushing on the bearing surfaces of the push rod guide bushing being in contact with a seal. An automatic manipulator of the apparatus moves in multi-axial directions relative the flange case. A tucking tool of the automatic manipulator holds the seal. The tool includes at least two members movable relative to one another. First member rotates around the axis of the tucking tool and presents a tucking surface for forcing the seal into the peripheral groove of the flange case. Second member gradually injects the seal into the peripheral groove and pushed the seal into the back wall of the peripheral groove.

### FIELD OF THE INVENTION

The present invention relates to an improved diaphragm-type pneumatic brake actuator for vehicle braking apparatus and more particularly to a method of installing a seal into a flange case of the brake actuator.

### BACKGROUND OF THE INVENTION

Pneumatic brake actuators form part of the pneumatic braking apparatus of commercial vehicles having a large gross vehicle weight, including trucks, buses and trailers requiring a braking apparatus which responds rapidly with substantial braking power. A typical diaphragm-type pneumatic brake actuator includes a housing having cup-shaped housing members including opposed rim or flange portions, a flexible diaphragm which is cup-shaped in its relaxed condition including a central portion, a generally conical side wall which surrounds the central portion and a generally radial rim portion which extends between the rim portions of the housing members. A brake actuator further includes a piston having a contact surface which engages the central portion of the diaphragm and which reciprocates with the central and side wall portions of the diaphragm in response to pneumatic pressure changes on opposed sides of the diaphragm from a first position. In response, the diaphragm is extended to a cup-shape, to a second inverted position to actuate the vehicle braking apparatus. The brake actuator is connected by pneumatic lines to the pneumatic braking apparatus of the vehicle to actuate the brake actuator. The piston is operably connected to the braking apparatus of the vehicle to actuate the vehicle brakes.

The brake actuator apparatus includes an emergency or spring chamber having a power spring which actuates the braking apparatus of the vehicle when the pneumatic pressure of the vehicle falls below a predetermined minimum or the parking brake is actuated by the vehicle operator. In a spring brake chamber, a power spring is located in the housing between the end wall and the piston. During normal operation of the vehicle, the pneumatic pressure from the vehicle is received in the power spring chamber on the side of the cup-shaped diaphragm opposite the power spring and piston, normally compressing the power spring. When the pneumatic pressure in the spring chamber falls below a predetermined minimum, the power spring expands and actuates the braking apparatus of the vehicle.

The spring and service chambers may be combined in a “piggyback” assembly as disclosed, for example, in U.S. Pat. No. 5,311,809 assigned to the assignee of this application. In this design, the assembly includes a central generally H-shaped flange case and the opposed ends of the flange case are enclosed by cup-shaped housing members to define a service chamber on one side of the flange case and a power spring chamber on the opposed side of the flange case. A central opening in the web portion of the flange case receives a pushrod having a head portion biased against the central portion of the diaphragm in the service chamber opposite the piston and power spring, such that the pushrod is driven against the piston in the service chamber to actuate the vehicle braking apparatus when the pressure in the spring chamber falls below a predetermined minimum pressure.

Currently, the seals are installed manually. Manual installation of the seals is not cost effective and presents a high likelihood of human error. To solve these problem, a prior art apparatus manufactured by Automated Industrial Apparatus, a company based in Erie, Pa., were used to install O-rings and seals of the type using automation apparatus to eliminate need of manual installation. To the extent practicable, these apparatus keep the seals on the same plane with the seal groove thereby shrinking the outside diameter of the seal by pushing the seal through the funnel. This method negatively impacts formation of perfect “seat contact” between the seal and the groove in which the seal is installed, which may result in voids between the seal groove and the seal creating opportunities for leakage of fluids, lubricants, and the like.

There has, therefore, been a longstanding need to improve methods and apparatus of seal installation. These and other problems have been solved by the improved apparatus and method described below.

### SUMMARY OF THE INVENTION

An apparatus of the present invention installs a seal into a generally H-shaped flange case of a brake actuator (not shown). The flange case includes a central web portion, an outer wall and radially extending flanges. A cover or head portion of the brake actuator includes an end wall, a side wall and a flange or a skirt portion. A flexible diaphragm extends between the flange case and the cover thereby forming a lower pneumatic chamber and an upper pneumatic chamber on opposed sides of the diaphragm. The flange case defines an opening in the web portion extending into a peripheral groove also defined in the web portion. The diameter of the peripheral groove is larger than the diameter of the opening wherein both the peripheral groove and the opening are coaxially aligned with one another. The peripheral groove and the opening circumscribe a push rod (not shown) movable axially in relation to the flange case.

An automatic device installs the seal into the peripheral groove through the opening defined in the web portion. Those skilled in the art will appreciate that the automatic device may be used in any applications that require installation of seals, O-rings, and the like and is not intended to limit the scope of the present invention. The automatic device presents an arm adaptable for multi-axial movement. A terminal portion of the arm includes a shaft extending through the terminal portion to a terminal end.

A seal holding element or guide is cooperable with the terminal end. A seal deflector is connected to the seal holding guide. A plunger includes a center pin and other seal engaging elements to be discussed below. The plunger is located inside the seal holding guide and is movable relative the seal holding guide. In the initial stage of seal installation, the seal is placed in position to be pushed upwardly into the seal holding guide. The seal is pushed by a lever and pneumatic cylinder. As the seal moves upwardly, the seal passes the seal deflector having an angled portion, which forces the upper portion of the seal towards of the center pin. A mandrel presenting a seal engaging surface or a mandrel surface is placed to abut the central web portion to capture the seal in the opening.

Alluding to the above, the seal holding guide is lowered toward the opening to insert the seal into the peripheral groove. The upper portion of the seal is biased by the back portion of the center pin while the lower portion of the seal is biased by the mandrel surface thereby causing the seal to fold. As the seal folds, the lower portion extends generally perpendicular to the upper portion thereby extending into the back side of the peripheral groove as the seal folds over on itself.

As the seal is driven into the peripheral groove, the center pin forces the seal to fold over itself. The seal guide is retracted relative the center pin to allow the plunger to enter the flange case. The plunger is raised to a point wherein the center pin is clear of the seal to allow the upper portion of the seal to flip into a generally perpendicular position relative the plunger. The plunger then moves to a seal engaging position to insert the pin in the middle of the seal.

Alluding to the above, the plunger includes a neck portion extending to an eccentric wiper or a tucking portion. The neck portion includes a peripheral wall. The peripheral wall presents the diameter being smaller than the diameter of the eccentric wiper. The bottom surface of the eccentric wiper presents a pocket portion defined therein for receiving and retaining the upper portion of the seal as the seal is forced by the plunger into the peripheral groove. The aforementioned center pin is located in the center of the bottom surface. The pocket portion is designed to guide the upper lip of the seal to pass the upper edge of the peripheral groove. The plunger is then lowered to drive the remaining portion of the seal in to the peripheral groove. The seal is then placed in its entirety into the peripheral groove.

To prevent any potential leaks and deformations of the seal that may result in response to the seal not being properly seated in the peripheral groove, it is important to ensure that proper “seal to groove” or “seat contact” is formed, whereby no void portions are formed between the peripheral groove and the seal. The plunger is placed in the position to spin about the axis thereby forcing the seal into the distal portion of the peripheral groove. The plunger is then moved upwardly enough to extend the edge of the eccentric wiper is between the upper edge of the peripheral groove and the upper lip of the seal. The plunger is then rotated to force the seal toward the mandrel surface. The seal is now properly seated in the peripheral groove of the web portion and the plunger is moved upwardly.

A seal installation device is cooperable with the automatic device. A pair of elements of the seal installation device is movable about respective axis and relative the automatic device. A first element slides along a second element for holding the seal between the elements as the seal installation device is moved adjacent the automatic device for inserting the seal into the holding guide. One of the elements is defined by a first slide having terminal ends. One of the terminal ends extends to a lip portion and another terminal end presents one of the respective axes. A support tower presents a plate defining a groove of a non-planar configuration for receiving the axis of the first slide thereby allowing the first slide to move along the groove as the first slide moves relative the automatic device. A second slide rotates about the other of the respective axis and moves along the first slide to and away from the lip portion to limit the distance between the lip portion and the second slide thereby trapping the seal between the first and second slides. A lever is cooperable with the first and second slides to insert the seal into the guide as the first and second slides are moved into a seal inserting position with the seal being trapped between the first and second slides.

An advantage of the present invention is to provide an improved apparatus and method for installing a seal into a seal groove defined in a flange case thereby eliminating need for manual installation.

Another advantage of the present invention is to provide an improved apparatus and method for installing the seal into the seal groove that is not cost effective and eliminates likelihood of human error.

Still another advantage of the present invention is to provide an improved apparatus and method for installing the seal into the seal groove that forms a perfect “seat contact” between the seal and the groove wherein the seal is installed, thereby eliminating problems of fluid leakage.

Other advantages and meritorious features of this invention will be more fully understood from the following description of the preferred embodiment, the appended claims, and the drawings; a brief description of which follows.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a fragmental view of a tucking tool of the present invention for installing a seal into a flange case of a brake actuator wherein the seal is in position by a seal installation device to be pushed upward into a seal guide of the tucking tool;

FIG. 2 illustrates the seal installation device with the seal, shown in phantom, in its moving position, before the seal is inserted into the flange case;

FIG. 3 illustrates the seal installation device in its seal insertion position, wherein the seal is inserted into the tucking tool;

FIG. 4 illustrates a fragmental view of the tucking tool wherein the seal is inside the seal guide and oriented to be inserted into the flange case defining a seal groove;

FIG. 5 illustrates yet another fragmental view of the tucking tool of the present invention wherein the seal is driven to the peripheral wall of the seal groove and a center pin of the tucking tool forces the seal to fold over itself;

FIG. 6 illustrates enlarged fragmental view of FIG. 5;

FIG. 7 illustrates enlarged fragmental view of a plunger;

FIG. 8 illustrates a fragmental view of the web portion and the seal positioned in the seal groove wherein a wiper portion of the plunger spins around the seal to seat the seal into the bottom of the seal groove before “seal to groove” contact is formed;

FIG. 9 illustrates yet another fragmental view of the tucking tool wherein the seal is already installed in the seal groove and the wiper portion of the plunger spins around the seal to seat the seal into the bottom of the seal groove before the tucking tool retracts from its tucking mode;

FIG. 10 illustrates cross sectional view of the tucking tool of the present invention as shown in FIG. 9 in various rotational modes; and

FIG. 11 illustrates a schematic view of seal engaging members of the seal installation tool in various positions.

### DETAILED DESCRIPTION OF THE INVENTION

Referring to the Figures, wherein like numerals indicate like or corresponding parts, an apparatus of the present invention is generally shown at 10. The apparatus 10 installs a seal 12 into a generally H-shaped flange case, generally indicated at 14, of a brake actuator (not shown). However, it should be understood to those of skill in the art that other case configuration requiring a seal are also contemplated by the inventor. The flange case 14 includes a central web portion 16, an outer wall or peripheral wall 18 and radially extending flanges 20 and 22. The brake actuator also includes other components (not shown) required to actuate the brake. A cover or head portion of the brake actuator includes an end wall, a side wall and a flange or skirt portion. A flexible diaphragm extends between the flange case and the cover thereby forming a lower pneumatic chamber and an upper pneumatic chamber on opposed sides of the diaphragm.

The flange case 14 defines an opening or aperture 24 in the web portion 16 having a peripheral wall 25 extending into a peripheral groove 26 also defined in the web portion 16. The diameter of the peripheral groove 26 is larger than the diameter of the opening 24 and peripheral wall 25. Both the peripheral groove 26 and the opening 24 are coaxially aligned. The peripheral groove 26 and the opening 24 circumscribe a push rod (not shown) movable axially in relation to the flange case 14. The groove 26 retains the seal 12 in a known manner to seal the pneumatic chamber of the brake actuator.

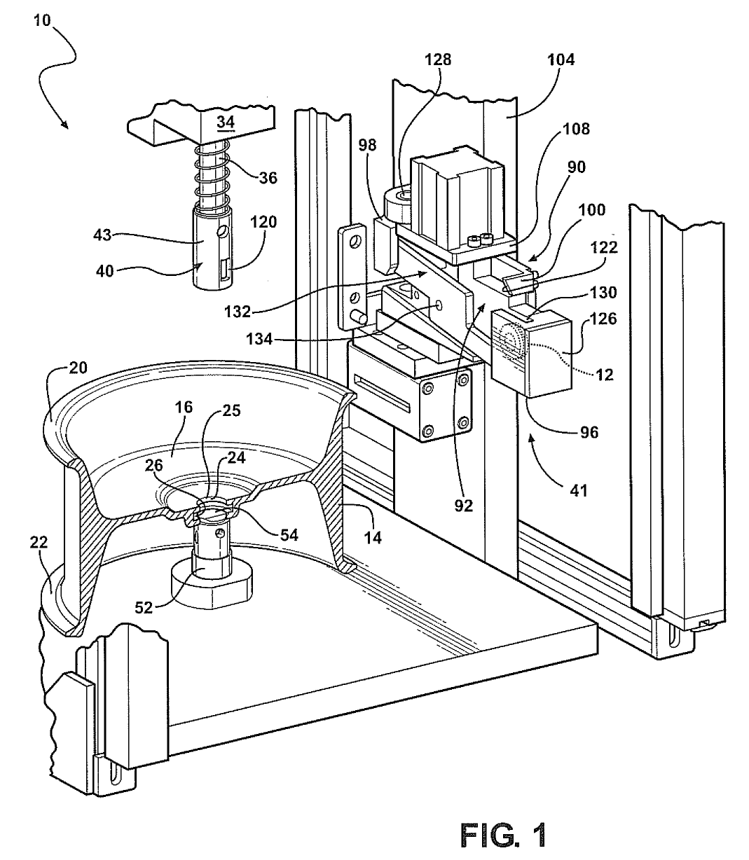

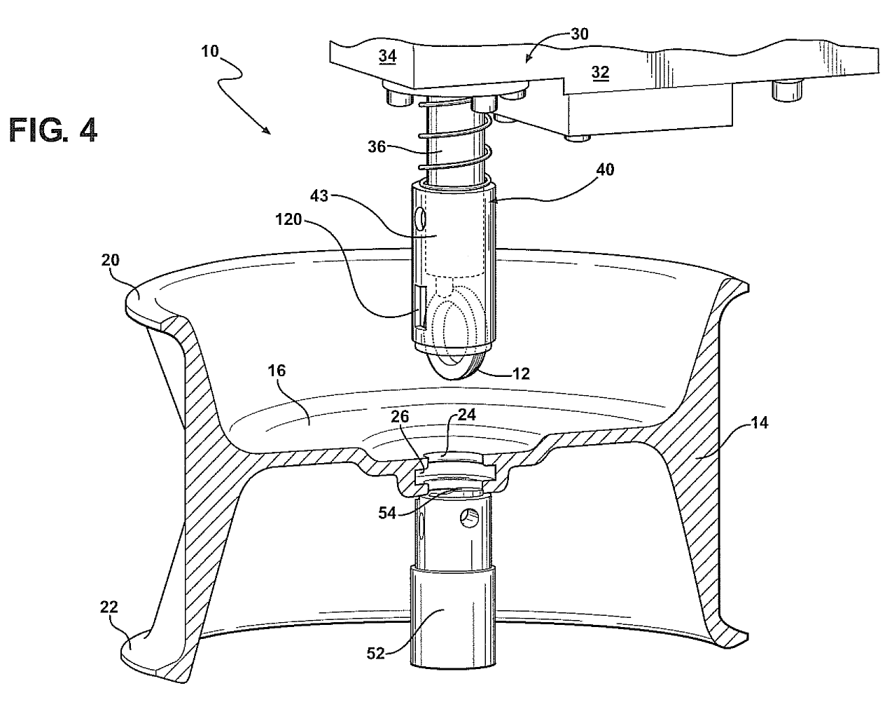

Referring to FIGS. 1 through 6, an automatic device, generally indicated at 30, installs the seal 12 into the peripheral groove 26 through the opening 24 defined in the web portion 16. Those skilled in the art will appreciate that the automatic device 30 may be used in any applications that require installation of seals, O-rings, and the like and is not intended to limit the scope of the present invention. The automatic device 30 presents an arm 32 adaptable for multi-axial movement. The arm 32 actuates in a vertical direction via pneumatic pressure. However, the arm 32 may also be actuated by way of hydraulic or servo motor as desired.

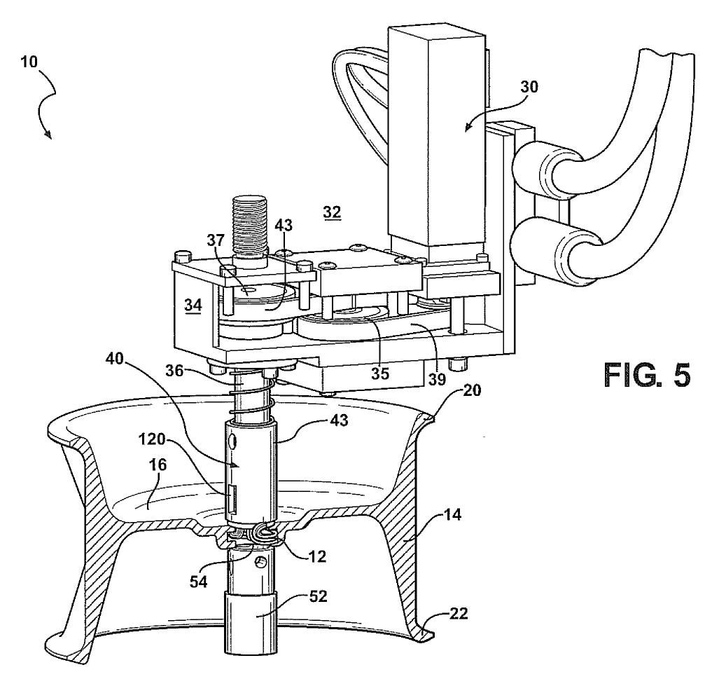

A terminal portion 34 of the arm 32 retains a shaft 36 (FIG. 5) that actuates in a vertical direction with the arm 32. A tucking tool 40 is formed from seal holding member (first member) or guide 43 for holding the seal 12 and is cooperable with a terminal end (second member) 38 that is a lower terminal end of the shaft 36. The second member 38 of the tucking tool 40 has a distal surface 45 that includes a center pin 44 and other seal engaging elements to be discussed below. The second member 38 acts as a plunger and telescopically extends through the guide 43 to insert the seal 12 into the aperture 24 as will become more evident below. In the initial stage of seal installation, the seal 12 is placed in position to be pushed upwardly into the seal holding guide 40. The seal 12 is pushed by a seal installation device, generally shown at 41 in FIGS. 1 through 3. The seal installation device 41 and its functional and mechanical aspects will be discussed in great details further below. The automatic device 30 is cooperable with the terminal portion 34 present at least two gears 35 and 37 and belts 39 and 43 encircling the gears 35 and 37, respectively, to rotate the holding guide 40. The gear 35 is rotated by a main shaft (not shown) extending from the automatic device 30. The type, configuration, layout, and arrangement of the gears 35 and 37 and belts 39 and 43 as illustrated in FIG. 5 are shown for illustrative purposes and are not intended to limit the scope of the present invention. Those skilled in the mechanical art will appreciate that other mechanical devices may be used in the present invention to rotate the holding guide 40.

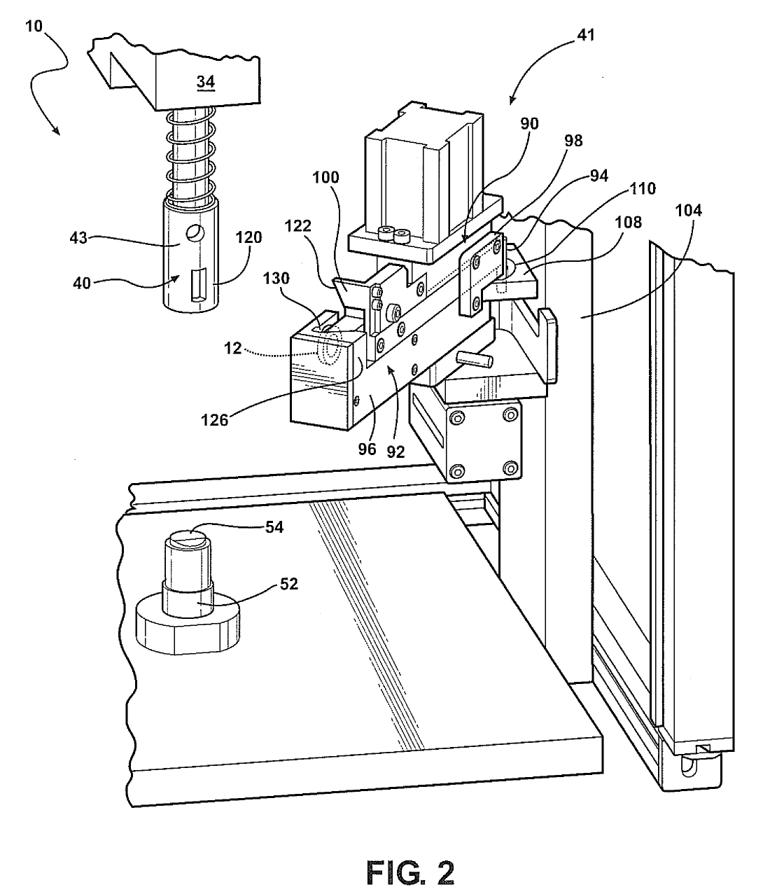

As best seen in FIGS. 1 and 2, a mandrel 52 presenting a seal engaging surface or a mandrel surface 54 is placed to abut the central web portion 16 to cover the opening 24 defined in the web portion 16 on an opposite side of the web portion 16 from the tucking tool 40. During installation, the seal holding guide 40 is lowered toward the opening 24 to insert the seal 12 into the peripheral groove 26.

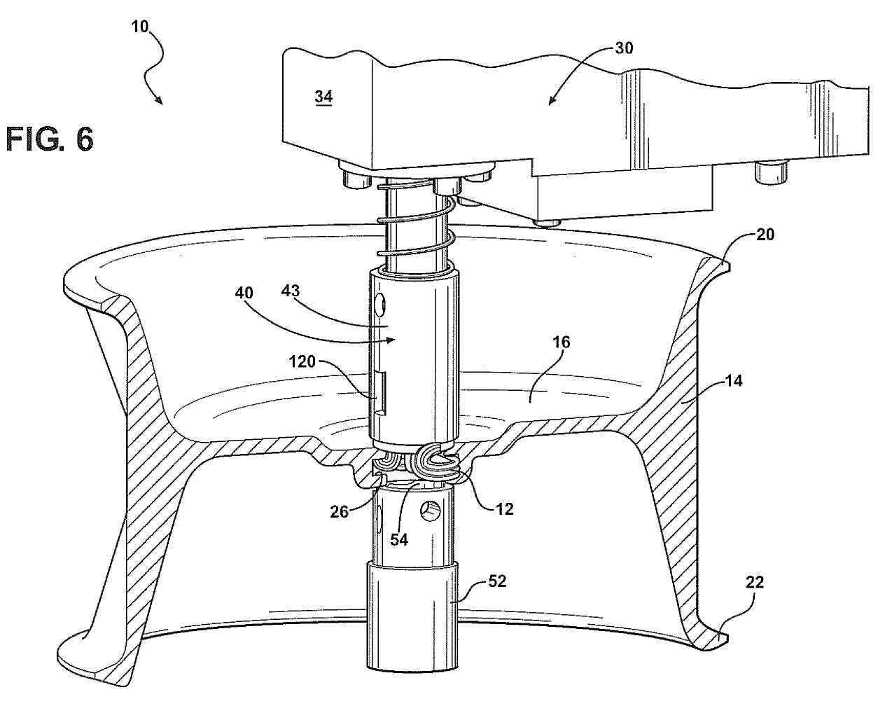

When the seal is ready for installation, the upper portion of the seal 12 is received by a pocket 50 in the distal surface 45 of the second member 38 and the lower portion of the seal 12 is biased toward the mandrel surface 54. The seal 12 is retained inside the first member or seal holder 43 in a distorted configuration by center pin 44. As best shown in FIGS. 5 and 6, the distorted seal 12 fits into the aperture 24, which has a narrower inside diameter than the outside diameter of the seal 12 due to the seal's 12 distorted configuration. Upon installation, the lower portion of the seal 12 is folded generally perpendicularly to the upper portion 48 as deflected by the mandrel surface 54 into the back side of the peripheral groove 26. The seal 12 is thus forced into the peripheral groove 26 as the center pin 44 forces the seal 12 to fold over upon itself. The seal guide 40, which is spring biased retracts relative the center pin 44 as the distal end 45 of the second member 38 telescopes to enter the aperture 24. The center pin 44 is spring loaded to bias outwardly from the distal surface 45 and compresses to allow the second member 38 to continue to force the seal into the aperture 24 and into the groove 26. A pocket 50 retains the seal 12 against the distal surface 45 of the second member 38 in a desired orientation while the center pin 44 retracts.

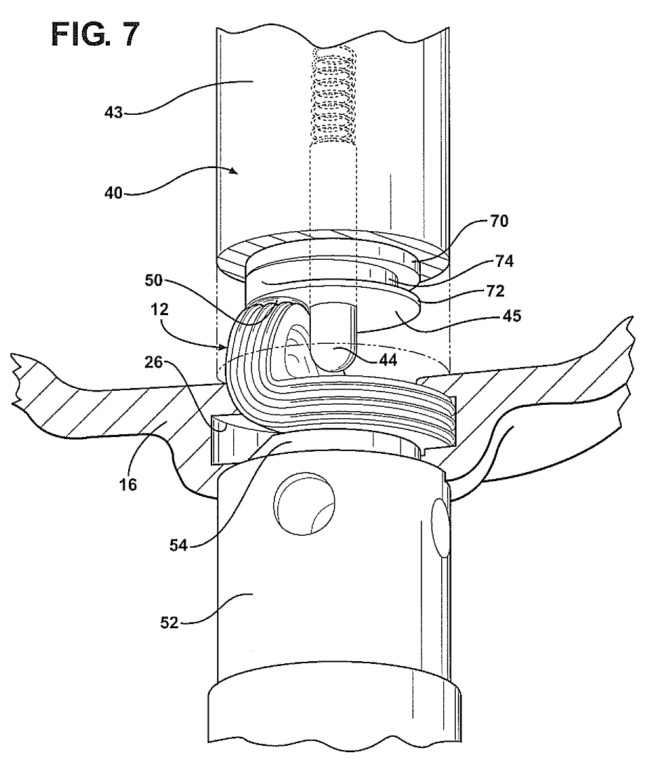

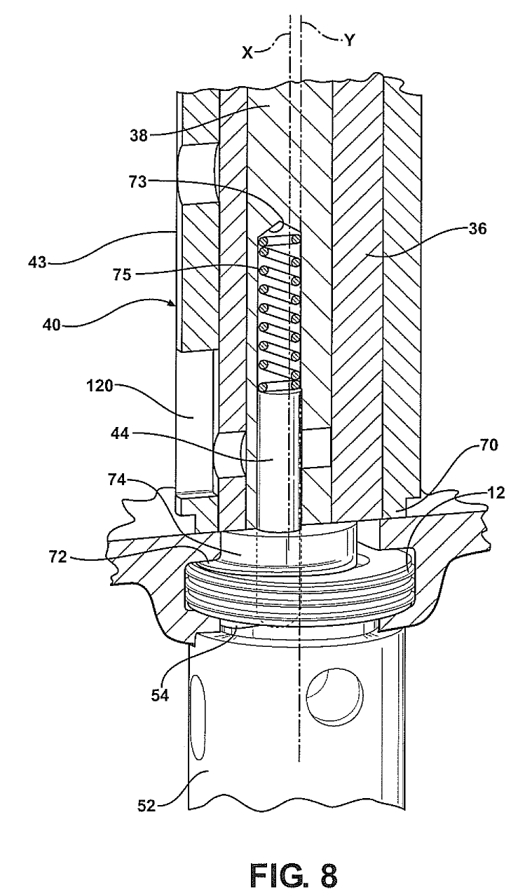

As best seen in FIGS. 7 and 8, the second member 38 includes a neck portion 70 extending to an eccentric wiper or a tucking portion 72. The neck portion 70 includes a peripheral wall 74 presenting a diameter that is smaller than the diameter of the eccentric wiper 72. FIG. 8 presents a cross sectional view of the tucking tool 40. The shaft 36 is located inside the guide 43 and present a first axes Y. The second member 38 is disposed inside the shaft 36. The second member 38 presents a second axes X being offset from the first axes Y. The second member 38 defines a cavity 73 to receive the center pin 44 and a spring 75 thereby allowing the center pin 44 to retract into the cavity 73. The offset defined between the axis X and the axis Y allows the eccentric wiper 72 to rotate about the axis Y and to drive the remaining portion of the seal 12 completely into the seal groove 26 to ensure that proper “seal to groove” or “seat contact” is formed between the peripheral groove 26 and the seal 12.

The complete installation of the seal is best explained when referring to FIGS. 6 through 9. The center pin 44, now having released the seal 12 is retracted into the cavity 73 defined in the second member 38. The pocket portion 50 now guides the upper lip of the seal 12 to past the upper edge 84 of the peripheral groove 26. The second member 38 is lowered to drive the remaining portion of the seal 12 in to the seal groove 26. The seal 12 is then placed in its entirety into the peripheral groove 26.

To prevent any potential leaks and deformations of the seal 12 that may result in response to the seal 12 not being properly seated in the peripheral groove, it is important to ensure that proper “seal to groove” or “seat contact” is formed between the peripheral groove 26 and the seal 12.

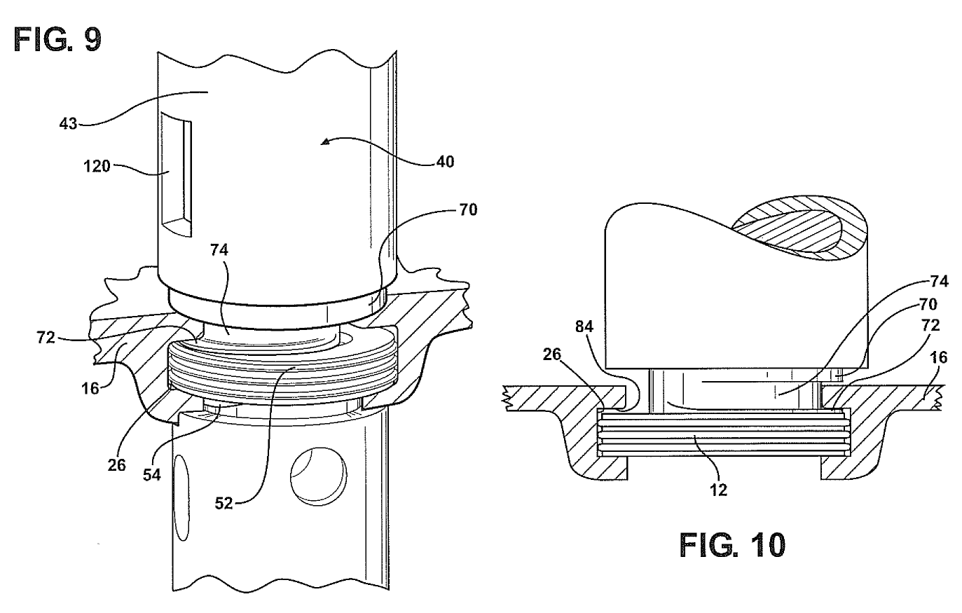

The eccentric wiper 72 is positioned between the upper edge 84 of the peripheral groove 26 the seal 12. The second member 38 is then rotated to force the seal 12 toward the mandrel surface 54 so that the eccentric wiper is located inside the groove 26 as best seen in FIGS. 9 and 10. The mandrel surface 54 provides space necessary to flex the seal 12 fully into the groove 26 with the eccentric wiper 72. The seal 12 is now properly seated in the peripheral groove 26 of the web portion 16 and the second member 38 is withdrawn. The second member 38 rotates on an axis that is offset from an axis defined by the aperture 24. The mandrel 52 is then disengaged from the H-shaped flange case 14. The apparatus 10 of the present invention may be integrated into an assembly line (not shown) or be utilized as a separate unit.

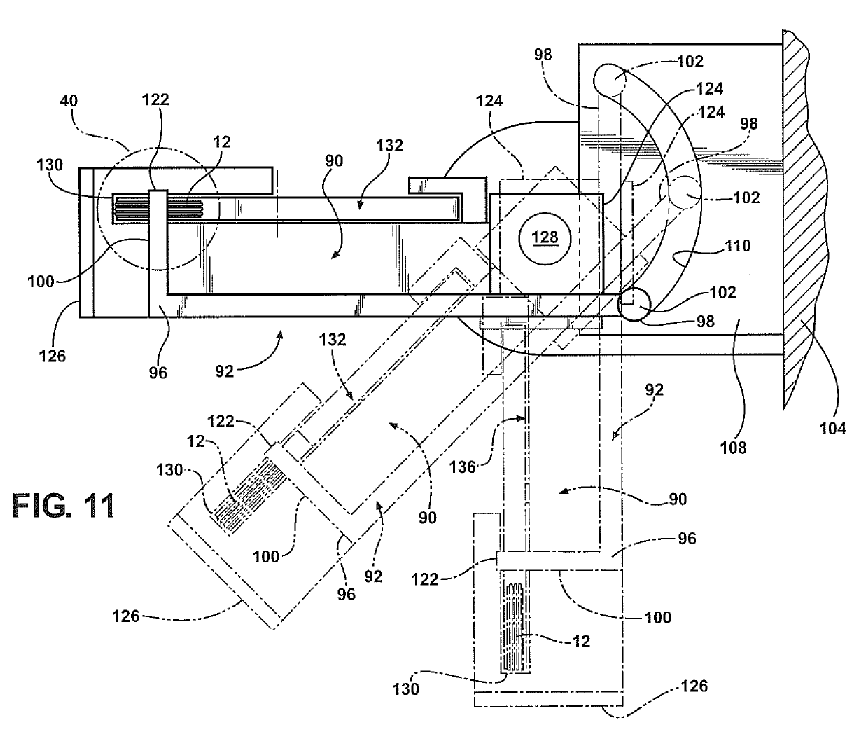

Another aspect of the inventive apparatus 10 is the delivery of the seal 12 to the tucking tool 40. This is best explained by referring again to FIGS. 1 through 3 and 11. The seal installation device or arm 41 includes a first element 90 and a second element 92. The second element 92 has terminal ends 96 and 98. One of the terminal ends 96 extends to a key portion 100. The opposing terminal end 98 includes a pin 102. A support tower 104 presents a plate 108 defining a groove 110 of a non-planar configuration, as best shown in FIG. 11. The groove 110 is designed to receive the pin 102 of the second element 92 thereby allowing the second element 92 to move along the groove 110 as the second element 92 moves relative the automatic device 30. The key portion 100 presents an angled seal contact 112 to deflect the seal 12 as the seal is inserted into the seal holding guide 43. The seal holding guide 40 defines a keyway 120 to receive the key portion 100 having the angled seal contact 112 as the seal 12 is inserted into the seal holding guide 40 to deform the seal around the center pin 44 as explained above.

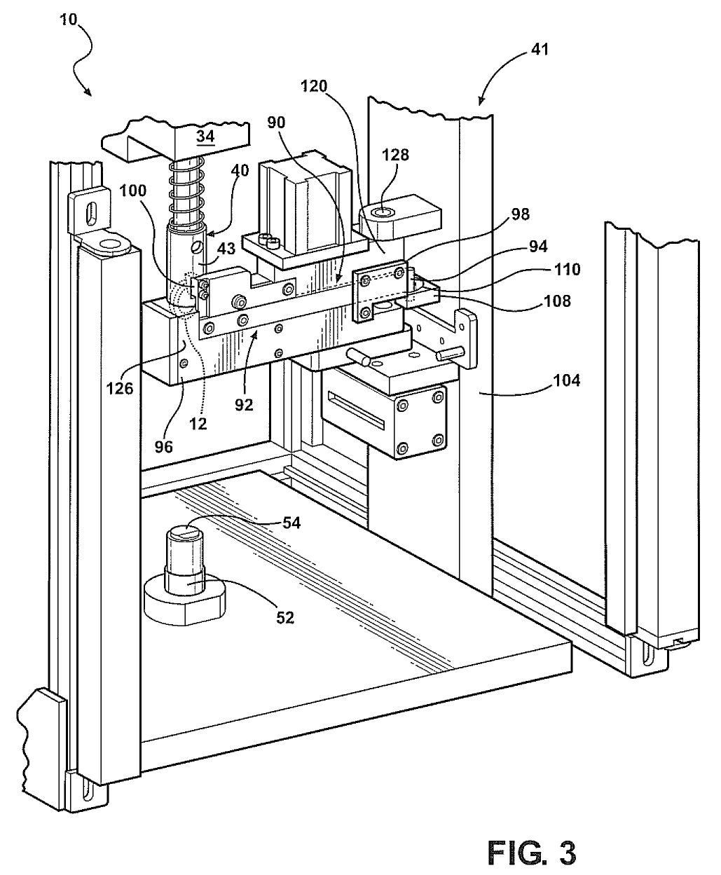

The first element 90 is positioned just below the second element 92 and pivots generally at the tower 104. The first element 90 includes terminal ends 124 and 126. The first terminal end 124 includes a first pivot pin 128. The second terminal end 126 presents a pocket 130 to receive and retain the seal 12 before the seal 12 is inserted into the guide 40. The seal 12 is placed into the pocket 130 manually or by an automatic insertion device or mixing bowl (not shown). As best shown in FIG. 11, the first element 90 is rotatable about the axis defined by pin 128, between a seal receiving or first position (FIG. 1) and a seal installation or second position (FIG. 3). Because the first element pivots at pivot pin 128 and the second element pivots in groove 110 the distal ends 126 and 96 very relatively between the first position and the second position of the arm 41. In the seal receiving or first position (FIG. 1) the key portion 100 is retracted from the pocket 130 providing access to insert a seal 12 into the pocket. When the arm is located in the seal installation or second position (FIG. 3) the key is position over the pocket 130 and is received in the keyway 120 to deflect the seal when lifted by lever 132. As the seal 12 is positioned below the seal holding guide 40, the lever 132, pivots upwardly to lift the seal 12 into the guide 40.

The apparatus 10 of the present invention provides numerous advantages over prior art apparatus and methods. The apparatus 10 of the present invention eliminates need of manual installation of the seal 12 into the peripheral groove 26 defined in the flange case 14 reducing manufacturing costs of the brake actuator and eliminates likelihood of human error. The apparatus 10 ensures that a perfect “seat contact” is consistently formed between the seal 12 and the peripheral groove 26 wherein the seal is installed eliminating problems associated with fluid leakage.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A apparatus for forming a brake actuator having a flange case including a web portion defining central aperture with peripheral wall defining a groove to receive a seal, said apparatus comprising:
a mandrel supporting the web portion of the flange case;
a tucking tool opposed to said mandrel having a first member and a second member movable relative to said first member along an axis defined by the central aperture, said first member configured to receive and retain the seal; and
said second member being rotatable around the axis defined by the central aperture and presenting a camming surface for forcing the seal from said first element into the groove defined by the peripheral wall of the central aperture of the flange case in cooperation with said mandrel.

2. An apparatus as set forth in claim 1, wherein said first member of said tucking tool is further defined as a tubular member coaxial with the axis defined by the central aperture for inserting the seal into the groove.

3. An apparatus as set forth in claim 1, including an arm having a seal holding element and being pivotal between a first position for receiving the seal and a second position for presenting the seal to said tucking tool.

4. An apparatus as set forth in claim 3, wherein said arm includes a cooperable member having a terminal end providing access to said seal holding element when said arm is in said first position.

5. An apparatus as set forth in claim 4, wherein said cooperable member includes a seal deflector disposed above seal holding element when said arm is disposed in said second position.

6. An apparatus as set forth in claim 5, wherein said seal deflector is received by said tucking tool when said arm is disposed in said second position thereby distorting the seal being transferred from said seal holding element to said tucking tool.

7. An apparatus as set forth in claim 1, wherein said first member of said tucking tool retains the seal in a distorted configuration having a distorted width less than an inside diameter of the peripheral wall of the central aperture.

8. An apparatus as set forth in claim 1, wherein said mandrel presents a seal engaging surface positioned to cooperate with said camming surface of said second member thereby forcing a portion of the seal into the groove while the seal is maintained in a distorted configuration.

9. An apparatus as set forth in claim 1, wherein said second member is further defined as a plunger having a neck portion extending beyond said first member into the central aperture thereby forcing the seal from the tucking tool into the central aperture.

10. An apparatus as set forth in claim 9, wherein said neck portion includes a peripheral wall presenting neck diameter and the camming surface presents a camming diameter smaller that is greater than the neck diameter.

11. An apparatus as set forth in claim 10, wherein said camming surface rotates into the groove thereby positioning the seal into the groove.

12. An apparatus for mechanically inserting a seal into a groove defined in a peripheral wall of an aperture through a fluidly sealed housing, said apparatus comprising:
a tucking tool for holding the seal in a deformed configuration necessary for inserting the seal through the aperture of the fluidly sealed housing and into the groove defined in the peripheral wall; and
a seal transfer arm for transferring the seal to the tucking tool, said seal transfer arm having a seal holding element orienting the seal to be received by the tucking tool and a cooperable member having a terminal end providing access to said seal holding element when said seal transfer arm is disposed in a first location and said terminal end at least partially constricting said seal holding element when said seal transfer arm is located in a second location thereby deforming the seal to the deformed configuration when the seal is being transferred to said tucking tool from said seal transfer arm.

13. An apparatus as set forth in claim 12, wherein said tucking tool comprises a tubular member for receiving the seal and in a deformed configuration.

14. An apparatus as set forth in claim 13, wherein said tucking tool includes a plunging member axially aligned with said tubular member for ejecting the seal from said tubular member.

15. An apparatus as set forth in claim 14, wherein said plunging member includes a distal face having a pin extending therefrom thereby retaining the seal in a deformed configuration inside said tubular member.

16. An apparatus as set forth in claim 13, wherein said plunging member includes a distal face having a pocket for receiving an end of the seal while the seal is held in a deformed configuration.

17. An apparatus as set forth in claim 13, including a mandrel disposed upon an opposite side of the housing from said tucking tool, said mandrel including.

18. An apparatus as set forth in claim 17 wherein said tucking tool includes a tubular member for receiving the seal, said tucking tool defining said axis and presenting fluid communication with a source of fluid supply.

19. An apparatus as set forth in claim 18 including an automatic device for installing the seal into the groove, said automatic device presenting an arm adaptable for multi-axial movement and fluidly communicated with said source of fluid supply.

20. An apparatus as set forth in claim 19 wherein said arm includes a terminal portion having a shaft extending through said terminal portion to a terminal end.

21. An apparatus as set forth in claim 20 including a seal holding element being cooperable with said terminal end.

22. An apparatus as set forth in claim 21 including wherein one of said members of said tucking tool is further defined by a plunger presenting a center pin, said plunger being located inside said seal holding element and movable relative said seal holding element.

23. An apparatus as set forth in claim 22 wherein said support surface is further defined by a mandrel presenting a seal engaging surface positioned to abut the central web portion to cover an opening defined in the web portion.

24. An apparatus as set forth in claim 23 wherein said plunger includes a neck portion extending to said tucking surface.

25. An apparatus as set forth in claim 24 wherein said neck portion includes a peripheral wall presenting the diameter being smaller than the diameter of said tucking surface.

26. An apparatus as set forth in claim 25 wherein said tucking surface includes a pocket portion defined therein for receiving and retaining the upper portion of the seal as the seal is forced by said plunger into the groove.

27. A method of inserting a seal into a seal groove disposed in an aperture wall of an aperture through a panel wherein the aperture wall includes a diameter narrower than the seal required to seal the aperture, comprising the steps of:
providing a tubular member having an ejector telescopically received by said tubular member;
inserting the seal into the tubular member oriented generally perpendicular to the aperture in the panel;
deforming the seal inside the tubular member so that the width of the seal disposed in a deformed configuration is less than the diameter of the aperture wall;
aligning the tubular member with the aperture disposed in the panel and forcing the seal into the aperture by telescoping the ejector from the tubular member; and
guiding the seal into the groove by rotating the ejector around the circumference of the seal thereby seating the seal the groove.

28. The method set forth in claim 27, wherein said step of guiding the seal into the groove is further defined by providing a mandrel to oppose the ejector on an opposite side of the panel thereby preventing the seal from passing through the aperture disposed in the panel.

29. The method set forth in claim 27, further including the step of providing a central pin on the ejector to retain the seal in a distorted configuration.

30. The method set forth in claim 27, further including the step of providing a wiper on the ejector and inserting the wiper into the groove when the ejector is rotated.

31. The method set forth in claim 27, further including the step of delivering the seal to the tubular member in an orientation perpendicular to the aperture disposed in the panel.
